(19) United States
(12) Patent Application Publication
(10) Pub. No.: US 2010/0297579 A1
(43) Pub. Date: Nov. 25, 2010

(54) Brace for holding a patient's mouth open during dental procedures

(76) Inventor: Arthur L. Beloff, Palm Beach, FL (US)

Correspondence Address: ROBERT M. DOWNEY, P.A., 6751 N. FEDERAL HWY., SUITE 300, BOCA RATON, FL, 33487, US

(21) Appl. No.: 12/454,623

(22) Filed: May 19, 2009

(51) Int. Cl. A61C 3/00

(52) U.S. Cl. 433/140

(57) ABSTRACT

A dental device includes a generally C-shaped member with upper and lower arms and a central spring arm extending therebetween. Rubber cradle members on the upper and lower arms comfortably engage the top and bottom teeth, while the spring arm urges the arm members apart. In a preferred embodiment, the rubber cradle members are fitted onto distal end positions of the upper and lower arms and are locked in place by serrated members on the distal end portions, thereby preventing slipping or accidental removal of the rubber cradles. Alternatively, the rubber cradle members may be permanently applied to the distal end portions by a dipping and coating process. When inserted and properly positioned between the upper and lower teeth, the device holds the mouth open and permits full access and movement of dental tools within the mouth in the performance of basic dental procedures, while eliminating strain on the patient's jaw muscles.

### BACKGROUND OF THE INVENTION

1. Field of the Invention

The present invention relates to dental devices and, more particularly, to a device for holding a patient's mouth open during dental procedures.

2. Discussion of the Related Art

The performance of any dental procedure requires the patient's mouth to be held open so that the dentist or hygienist can have access to the oral cavity and, particularly, the tooth (teeth) and/or gums that require dental work. When performing a lengthy procedure, such as a full dental examination or teeth cleaning, a patient's jaw muscles can become strained and fatigued from holding the mouth open for an extended period of time. To relieve the strain on the patient's jaw muscles and provide a more pleasant experience for the dental patient, there is a need for a device which comfortably holds the mouth open during dental procedures.

In the past, others have proposed various dental devices which engage the upper and lower teeth to hold the mouth open in a matter which allows a dentist or hygienist to perform a procedure in an isolated area of the mouth. These various devices are cumbersome and restrict access to only a limited area of the mouth. There remains an urgent need in the dental industry for a low profile device that holds a patient's mouth wide open, while permitting full access to the oral cavity so that a dentist or hygienist can perform basic dental procedures without the patient straining his/her jaw muscles.

### OBJECTS AND ADVANTAGES OF THE INVENTION

With the foregoing in mind, it is a primary object of the present invention to provide a simple dental device for propping open the mouth of a dental patient to facilitate oral examinations and treatment, while eliminating strain on the patient's jaw muscles.

It is a further object of the present invention to provide a simple dental device for holding a patient's mouth open during dental procedures, and wherein the device allows the dentist or hygienist full access to the oral cavity.

It is still a further object of the present invention to provide a simple dental device for holding a patient's mouth open during dental procedures, and wherein the device is manufactured to be a low cost, sterile packaged product that is disposable.

It is still a further object of the present invention to provide a simple dental device for holding a patient's mouth open during basic dental procedures, and wherein the device can be provided in different sizes to accommodate patients of all age groups and size.

It is still a further object of the present invention to provide a simple dental device for holding the mouth of a patient open during basic dental procedures, and wherein the device is provided with teeth engaging cradles having a rubber material exterior structure for comfortably engaging and supporting a patient's teeth while the device holds the patient's jaw open.

These and other objects and advantages or the invention are more readily apparent with reference to detailed description and drawings.

### SUMMARY OF THE INVENTION

The present invention is directed to a dental device for holding a patient's mouth open during oral examinations and dental procedures. The device comprises a molded, generally C-shaped member with upper and lower arms and a central spring arm extending therebetween. Rubber cradles on the upper and lower arms comfortably receive the upper and lower teeth against the corresponding upper and lower arms. The teeth are comfortably captivated within the rubber cradles, while the spring arm urges the arms away from one another towards a normally relaxed position, thereby holding the patient's mouth open without strain on the jaw muscles.

Squeezing the upper and lower arms towards one another, against the force of the central spring arm, allows placement and removal of the device from between and upper and lower teeth. Pressure application areas on the upper and lower arms, between the rubber cradles and central spring arm, allow for application of the squeezing force using the thumb and forefinger. When the device is properly inserted, the patient's mouth is held open with the front upper and lower teeth separated by approximately 1.5 inches. This allows the dentist or hygienist full access and movement of dental instruments within the oral cavity to perform basic dental procedures, while the patient rests comfortably without straining the jaw muscles to hold the mouth open during the procedure.

### BRIEF DESCRIPTION OF THE DRAWINGS

For a fuller understanding of the nature of the present invention, reference should be made to the following detailed description taken in conjunction with the accompanying drawings in which:

FIG. 1 is a side elevational view of the dental device of the present invention shown with rubber teeth engaging cradles removed from serrated distal end portions of upper and lower arms of the device;

FIG. 2 is a side elevational view, in partial cross-section, showing the dental device; and

FIG. 3 is a perspective view illustrating insertion and positioning of the dental device between teeth on the upper and lower jaw to thereby hold a patient's mouth open.

Like reference numerals refer to like parts throughout the several views of the drawings.

### DETAILED DESCRIPTION OF THE PREFERRED EMBODIMENT

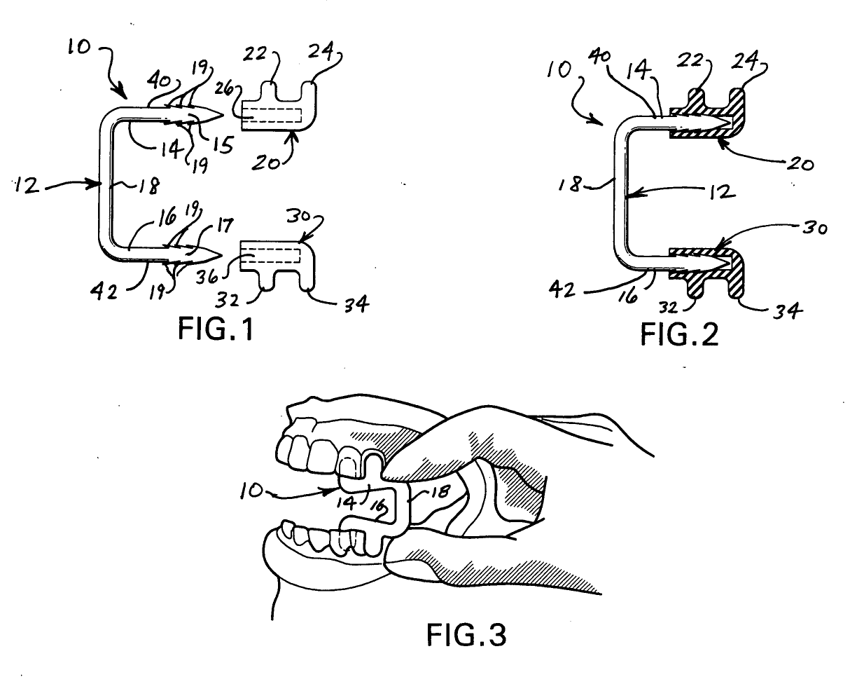

The dental device of the present invention is shown in FIGS. 1-3 and is generally indicated as 10. Referring initially to FIG. 1, the dental device 10 includes a generally C-shaped member 12 that is formed as a one piece, integral unit, preferably from a molded plastic composition. The C-shaped member 12 includes an upper arm 14, a lower arm 16 and a central spring arm 18 extending between the upper and lower arms. When in a relaxed position, as seen in FIGS. 1 and 2, the upper and lower arms extend outwardly from the spring arm 18 and slightly away from one another.

The upper arm 14 is provided with a rubber cradle 20 on a distal end portion 15. The rubber cradle 20 includes upwardly projecting members 22 and 24 and is specifically structured for comfortable, nested receipt of an upper tooth of a patient between the projections 22, 24. Similarly, the lower arm 16 is provided with a rubber cradle 30 on its distal end portion 17. The cradle 30 on the lower arm is structured for comfortable, nested receipt of a bottom tooth of a patient therein, and between the projections 32, 34 on the rubber cradle 30.

In a preferred embodiment, the rubber cradles 20 and 30 are provided as independent pieces that are fitted to the respective distal end portions 15 and 17 on the upper and lower arms 14, 16. Each rubber cradle is molded to include the spaced apart projecting members and a cavity for receiving the distal end portion. Specifically, the upper rubber cradle 20 is formed with a hollow cavity 26 that is sized and dimensioned for receiving the distal end portion 15 of the upper arm 14. Likewise, the lower rubber cradle 30 is formed to include hollow cavity 36 that is sized and dimensioned for snug fitted receipt of the distal end portion 17 of the lower arm 16. Both distal end portions 15 and 17 are formed with serrated members 19 for locking the rubber cradles 20 and 30 in attached engagement on the distal end portion. Specifically, the serrated members 19 are angled to promote sliding receipt of the respective distal end portions within the cavities of the rubber cradles 20 and 30. However, removal of the rubber cradles 20 and 30, once attached, is prevented due to the serrated members engaging the rubber material within the hollow cavities. More specifically, the angled positioning of the serrated members causes them to bite into the rubber material upon applying a pulling force in an attempt to remove the rubber cradles from the distal end portions. Accordingly, the serrated members 19 serve to prevent the rubber cradles 20 and 30 from slipping or accidentally separating from the upper and lower arms 14, 16. In an alternative embodiment, the rubber material on the exterior surface of the cradles can be applied by a dipping and coating process. In this instance, the distal end portion 15 and 17 are molded to form the general shape of the cradles, including the spaced apart projecting members. The exterior rubber surface is then applied by dipping the distal end portions in a liquid rubber composition. This process may be repeated several times to provide the desired thickness of the rubber coating.

The upper and lower arms are flexible, relative to one another, by applying a inwardly directed squeezing force. Specifically, application of a squeezing force on pressure application surfaces 40 and 42 causes the central spring arm 18 to flex so that the rubber cradles 20 and 30 on the upper and lower arms 14, 16 move towards one another, thereby reducing the distance of separation therebetween. This allows for placement and removal of the device 10 within the patient's mouth between the upper and lower teeth. Specifically, to insert the device, the device 10 is held between the thumb and forefinger, grasping the device at the pressure application surfaces 40, 42. The device is then inserted into the mouth so that one or two adjacent teeth are received between members 22 and 24 on the rubber cradle 20 of the upper arm 14. The device 10 should be positioned in the area away from the side of the mouth that the dentist or hygienist plans to work on. Then, by applying inward pressure on the pressure application surfaces 40, 42, in a gentle squeezing action, the separation between the cradles 20, 30 is reduced and the bottom cradle 30 can be positioned onto the one or two adjacent bottom teeth directly below the upper teeth that are within the upper cradle 20. Specifically, the bottom teeth are positioned between members 32 and 34 of the rubber cradle 30. Once in position, the squeezing force is released and the central spring arm 18 urges the upper and lower arms away from one another and towards the relaxed position, thereby holding the patient's jaw open. The device 10, when properly positioned to the hold the mouth open, permits full access and movement of dental instruments within the oral cavity to perform basic dental procedures, while eliminating strain on the patient's jaw muscles.

While the present invention has been shown and described in accordance with a preferred and practical embodiment thereof, it is recognized that departures from the instant disclosure are fully contemplated within the spirit and scope of the invention.

What is claimed is:

1. A dental brace adapted for placement between upper and lower teeth to hold a patient's jaw open during dental procedures, said dental brace comprising:
a generally C-shaped member formed of a rigid, yet flexible material includes an upper arm with a distal end portion, a lower arm with a distal end portion, and a central spring arm spanning between the upper and lower arms, and said central spring arm being structured and disposed to yield and flex in response to opposing external forces applied to said upper and lower arms to allow the distal end portions of the upper and lower arms to move from a normally relaxed position and towards one another while said central spring arm maintains a resilient biasing force on said upper and lower arms urging said distal end portions back to the normally relaxed position;
an upper cradle on said distal end portion of said upper arm and including a pair of spaced upwardly projecting members sized, structured and configured for receiving at least one upper tooth therebetween;
a lower cradle on said distal end portion of said lower arm and including a pair of spaced downwardly projecting members sized, structured and configured for receiving at least one lower tooth therebetween; and
whereby the dental brace holds the patient's jaw open and permits access and movement of dental tools within the patient's mouth during the performance of dental procedures.

2. The dental brace as recited in claim 1 wherein said upper and lower cradles have a rubber exterior surface.

3. The dental brace as recited in claim 1 wherein said upper and lower cradles are formed of a molded rubber composition.

4. The dental brace as recited in claim 3 wherein said upper and lower cradles each include a hollow cavity for receiving the distal end portion of a respective one of the upper and lower arms therein, to thereby attach the upper and lower cradles to the distal end portions of the upper and lower arms.

5. The dental brace as recited in claim 4 wherein said distal end portions of the upper and lower arms are provided with serrated members for securing the upper and lower cradles thereon, and for discouraging slipping and removal of the upper and lower cradles from the distal end portions.

6. A dental brace adapted for placement between upper and lower teeth to hold a patient's jaw open during dental procedures, said dental brace comprising:
a generally C-shaped member formed of a rigid, yet flexible material includes an upper arm with a distal end portion, a lower arm with a distal end portion, and a central spring arm spanning between the upper and lower arms, and said central spring arm being structured and disposed to yield and flex in response to opposing external forces applied to said upper and lower arms to allow the distal end portions of the upper and lower arms to move from a normally relaxed position and towards one another while said central spring arm maintains a resilient biasing force on said upper and lower arms urging said distal end portions back to the normally relaxed position;
an upper cradle on said distal end portion of said upper arm and including a pair of spaced upwardly projecting members sized, structured and configured for receiving at least one upper tooth therebetween, and said upper cradle having a rubber exterior surface for engaging the at least one upper tooth;
a lower cradle on said distal end portion of said lower arm and including a pair of spaced downwardly projecting members sized, structured and configured for receiving at least one lower tooth therebetween, and said lower cradle having a rubber exterior surface for engaging the at least one lower tooth; and
whereby the dental brace holds the patient's jaw open and permits access and movement of dental tools within the patient's mouth during the performance of dental procedures.
